(19) United States
(12) Patent Application Publication
(10) Pub. No.: US 2026/0211561 A1
(43) Pub. Date: Jul. 23, 2026

(54) PROTECTING DATA IN AN UNLOCKED STORAGE DEVICE

(71) Applicant: Sandisk Technologies, Inc., Milpitas, CA (US)

(72) Inventors: GANESH KUMAR PATHIRAKANI, Bangalore (IN); DHARMARAJU MARENAHALLY KRISHNA, Bangalore (IN); SUNDAR PRASAD, Bangalore (IN); ESHWARAN MANIKODI, Bangalore (IN)

(73) Assignee: Sandisk Technologies, Inc., Milpitas, CA (US)

(21) Appl. No.: 19/033,889

(22) Filed: Jan. 22, 2025

(51) Int. Cl. G06F 3/06

(52) U.S. Cl. CPC G06F 3/0622; G06F 3/0637; G06F 3/0679

(57) ABSTRACT

A storage device may secure data stored on a memory device when the storage device is unlocked. The storage device may include a memory device to store data. A controller on the storage device may identify at least one logical zone associated with the memory device and establish a first data restriction policy associated with a logical zone to enforce access rules when the storage device is unlocked. The controller may set at least one bit in a command structure to establish a data protection policy for the logical zone. The controller may execute the first data restriction policy when the storage device receives a request to access data in the logical zone.

### BACKGROUND OF THE INVENTION

A storage device may be communicatively coupled to a host and to non-volatile/persistent memory including, for example, a NAND flash memory device on which the storage device may store data received from the host. The memory device may include multiple dies which may be divided into physical blocks and the storage device may store data in blocks on the memory device. The host may address the data stored in the blocks on the memory device using logical block addresses that may be mapped to physical addresses on the memory device.

When the storage device has multiple users, to provide access (including, for example, read and/or write access) to data on the memory device to a subset of users, the memory device may be logically partitioned into dedicated drives such that one or more users of the storage device may access data stored in a partition/dedicated drive. For example, although all of the users of the storage device may be able to see the files stored on the memory device, a first user or a first set of users may access data in a first partition and a second user or a second set of users may access data in a second partition. If the memory device is not logically partitioned into dedicated drives, all users authorized to access the storage device may have equal access to the data stored on the memory device. As such when the memory device is not logically partitioned into dedicated drives, the first user or first set of users and the second user or second set of users may have equal access to the data stored on the memory device.

The data stored on the memory device may be protected from unauthorized read and/or write access with, for example, a lock/unlock password mechanism that may prevent unauthorized access to the storage device or to a logical partition. For example, if the memory device is not partitioned, the password mechanism may be used to prevent unauthorized access to the data stored on the memory device. If the memory device is divided into, for example, two partitions, the password mechanism may prevent, for example, the first user that does not have access to the second partition from accessing that partition.

After the password mechanism is set up, when an authorized user provides a valid password to the storage device, a controller on the storage device may unlock the storage device. Thereafter, a user may access a logical partition by providing the appropriate authentication credentials to access that partition. After the storage device is unlocked, it remains unlocked until it is locked again or until the storage device goes through a power recycle. When the storage device is left in an unlocked state, any user or host application may read data from, write data to, or modify data stored on the memory device via a background operation, with or without the knowledge of the owner of the data. Hence, when the storage device is unlocked, there is a need to prevent unauthorized read and/or write data access without having to create dedicated partitions.

### SUMMARY OF THE INVENTION

In some implementations, a storage device may secure data stored on a memory device when the storage device is unlocked. The storage device may include a memory device to store data. A controller on the storage device may identify at least one logical zone associated with the memory device and establish a first data restriction policy associated with a logical zone to enforce access rules when the storage device is unlocked. The controller may set at least one bit in a command structure to establish a data protection policy for the logical zone. The controller may execute the first data restriction policy when the storage device receives a request to access data in the logical zone.

In some implementations, a method is provided on the storage device for securing data stored on a memory device when the storage device is unlocked. The method includes identifying at least one logical zone associated with the memory device and establishing a first data restriction policy associated with a logical zone to enforce access rules when the storage device is unlocked. The method also includes setting at least one bit in a command structure to establish a data protection policy for the logical zone. The method further includes receiving an access request to access data associated with the logical zone and executing the first data restriction policy.

In some implementations, a method is provided for securing data stored on a memory device when the storage device is unlocked. The method includes identifying at least one logical zone associated with the memory device and establishing a first data restriction policy associated with a logical zone to enforce access rules when the storage device is unlocked. The method also includes establishing a second data restriction policy associated with data in the logical zone. The method further includes setting at least one bit in a command structure to establish a data protection policy for the logical zone. The method also includes receiving a first access request to access the logical zone, executing the first data restriction policy, receiving a second access request to access the data in the logical zone; and executing the second data restriction policy.

### BRIEF DESCRIPTION OF THE DRAWINGS

FIG. 1 is a schematic block diagram of an example system in accordance with some implementations.

FIG. 2 is an example block diagram showing logical zones associated with a memory device in accordance with some implementations.

FIG. 3 is an example block diagram of a command used to set the data restriction policy for a logical zone in accordance with some implementations.

FIG. 4 is another example block diagram of a command used to set the data restriction policy for a logical zone in accordance with some implementations.

FIG. 5 is an example block diagram of a command used to set the data restriction policy for a file in a logical zone in accordance with some implementations.

FIG. 6 is an example flow diagram for securing data on an unlocked storage device that is not partitioned in accordance with some implementations.

FIG. 7 is another example flow diagram for securing data on an unlocked storage device that is not partitioned in accordance with some implementations.

FIG. 8 is a diagram of an example environment in which systems and/or methods described herein are implemented.

FIG. 9 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

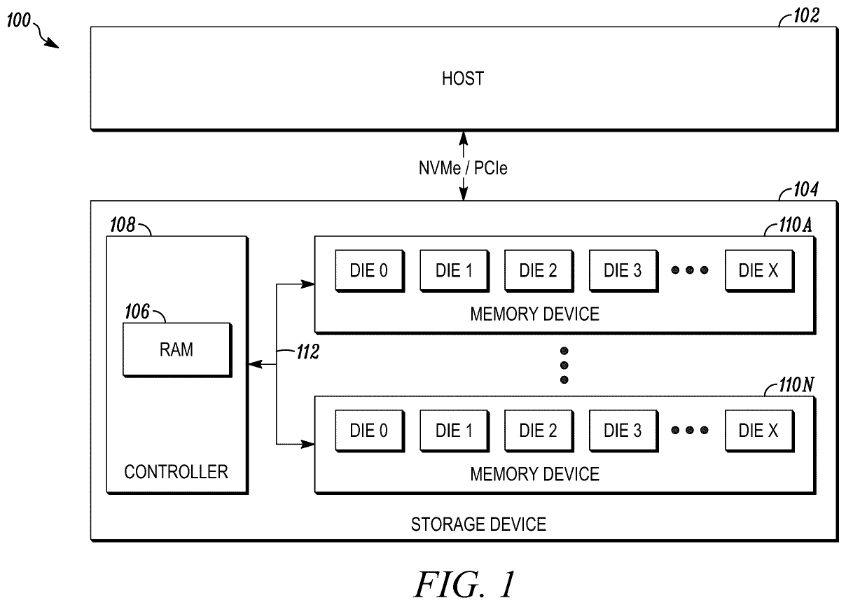

FIG. 1 is a schematic block diagram of an example system in accordance with some implementations. System 100 may include a host 102 and a storage device 104 that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may include a random-access memory (RAM) 106, a controller 108, and one or more non-volatile memory devices 110a-110n (referred to herein as the memory device(s) 110). Storage device 104 may be, for example, a solid-state drive (SSD). RAM 112 may be, for example, static RAM (SRAM) or dynamic RAM (DRAM) that be used to temporarily store data on storage device 104.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include one or more dies (for example, DIE 0-DIE X) connected to a memory bus 112 including data lines and chip enable lines. The dies may be divided into blocks to store the data. Memory device 110 may be included in storage device 104 or may be otherwise communicatively coupled to storage device 104. FIG. 1 is provided as an example.

Host 102 may address the data stored in the blocks on memory device 110 using logical block addresses (LBAs) that may be mapped to physical addresses on memory device 110. The LBAs may be grouped into one or more logical zones of varying sizes such that each logical zone may include a range of LBAs. For example, if the size of memory device 110 is 256 gigabytes, four logical zones may be associated with memory device 110, wherein the size of each logical zone may be sixty-four gigabytes. In another example, if the size of memory device 110 is 256 gigabytes and four logical zones are associated with memory device 110, the size of the first logical zone may be thirty-two gigabytes, the size of the second and third logical zones may be sixty-four gigabytes, and size of the fourth logical zone may be ninety-six gigabytes. The data associated with the LBAs in a logical zone may be stored on any physical location on memory device 110. The number of logical zones associated with memory device 110 and the size of each logical zone may be stored in a zone table. The zone table may be created when storage device 104 is manufactured and may be updated to change the number and sizes of logical zones associated with memory device 110.

Controller 108 may use a data restriction policy (also referred to here as a first data restriction policy) associated with a logical zone to enforce access rules when the storage device is unlocked. For example, controller 108 may restrict write/modify access and/or read access for specific files/folders stored on memory device 110 without creating dedicated partitions. In an implementation, controller 108 may use a command, for example, CMD42, to establish the first data restriction policy for a logical zone. Controller 108 may set a bit (referred to herein is a first bit) to establish the data protection policy for a logical zone. For example, controller 108 may set the first bit to an enabled state to set read protection control over a logical zone or set the first bit to a disabled state to remove read protection control from the logical zone. Controller 108 may also set the first bit to an enabled state to set write protection control over a logical zone or set the first bit to a disabled state to remove write protection control from the logical zone. In cases where the first data restriction policy for logical zone allows for read protection and write protection, controller 108 may set the first bit to an enabled state to set read protection control over a logical zone or set the first bit to a disabled state to remove read protection control from the logical zone and set a second bit to an enabled state to set write protection control over the logical zone or set the second bit to a disabled state to remove write protection control from the logical zone.

Controller 108 may also set one or more bits (referred to herein is a third bit(s)) to indicate the LBA zone identifier. In one example, where four logical zones are associated with memory device 110 and controller 108 is using the first bit, for example, Bit 5 in CMD42, for read protection control or write protection control and controller 108 may use two unused bits (third bits), for example, Bits 6 and 7 in CMD42, to identify the logical zone number associated with the data protection policy. If, for example, more than four logical zones are associated with memory device 110, controller 108 may add one or more bytes to the CMD42 structure to identify the logical zone number associated with a data protection policy. For example, controller 108 may add one byte to the CMD42 structure to identify up to 256 logical zones.

In an implementation, when storage device 104 is unlocked and controller 108 receives a host read request to read data from memory device 110, controller 108 may identify the logical zone where the data to be read is stored. Controller 108 may obtain the first data restriction policy for the logical zone. If the read protection control is enabled for the logical zone, controller 108 prompt the requestor (for example, host 102) to provide authentication credentials that may be used to ensure that host 102 is authorized to read data from the logical zone. For example, controller 108 prompt host 102 to provide a password for the logical zone to enable host 102 to read data from the logical zone. Host 102 may, for example, display an interface for a user seeking read access to the data such that the user may enter a password for the logical zone. When host 102 receives the password from the user, host 102 may transmit the password to storage device 104. When the password is authenticated, storage device 104 may execute the read request. If storage device 104 is unable to authenticate the password, storage device 104 may deny the read request. If the read protection control is disabled for the logical zone, when storage device 104 receives the read request, controller 108 may read the data and send the data to host 102 without requesting that host 102 provide authentication credentials.

When storage device 104 is unlocked and controller 108 receives a host write request to write data to memory device 11, and/or modify data stored on memory device 110, storage device 104 may prompt host 102 to select the logical zone to which the data may be written. In response to the prompt, for example, a user on host 102 may select a logical zone and host 102 may provide that information to storage device 104. Controller 108 may check for the first data restriction policy for the logical zone. If the write protection control is enabled for the logical zone identified by host 102 and if the first data restriction policy for the logical zone indicates that authentication is needed, controller 108 may prompt host 102 to provide authentication that may be used to ensure that host 102 is authorized to write data to the logical zone. For example, controller 108 prompt host 102 to provide a password for the logical zone to enable host 102 to write data to the logical zone. If host 102 provides authentic credentials, controller 108 may write the data to memory device and associate the LBA(s) in the data with the appropriate logical zone. If the first data restriction policy for the logical zone does not require authentication from host 102, controller 108 may write the data to memory device 110 without requesting that host 102 provide authentication credentials.

During a write operation if the data is to be written to multiple logical zones, controller 108 may use the starting LBA in the write operation to identify the first data restriction policy that will be enforced. For example, if data for a write operation spills from the first logical zone to the second logical zone and the starting LBA for the write operation is in the first logical zone, controller 108 may enforce the first data restriction policy for the first logical zone. During garbage collection, controller 108 may relocate the data and update the logical zone password associated with the relocated data or perform block swaps to hot and cold blocks.

In an implementation, controller 108 may further protect data in a logical zone. In addition to requiring authentication credentials to access a logical zone in accordance with the first data restriction policy for the logical zone, controller 108 may also set the data restriction policy for one or more files in the logical zone (referred to herein as a second data restriction policy) using a command such as, for example, CMD42. Controller 108 may add one or more bytes to CMD42 structure to identify a start LBA and an end LBA for data that is being protected in the logical zone.

Controller 108 may thus protect data stored on memory device 110 without partitioning storage device 104 into multiple partitions/dedicated drives. Controller 108 may enforce the first data restriction policy for one or more logical zones with different authentication credentials for the logical zones. Although a user, for example, host 102 may view the full capacity of storage device 104, the data stored on memory device 110 may have varied access protections. In an example where the total user capacity of storage device 104 is 256-gigabytes and storage device 104 is being accessed by three hosts 102a, 102b, and 102c. If storage device 104 includes three logical zones such that a first logical zone is associated with host 102a, a second logical zone is associated with host 102b, and a third logical zone is associated with host 102 c, hosts 102 a, 102 b, and 102 c may view storage device 104 capacity as 256-gigabytes. However, controller 108 may enforce data restriction policies for the logical zones so that host 102a may access the first logical zone with the appropriate credentials, host 102b may access the second logical zone with the appropriate credentials, and host 102c can access the third logical zone with the appropriate credentials. Controller 108 may further enforce data restriction policies for one or more filed in a logical zone. For example, when host 102a provides the appropriate credentials and is granted access to the first logical zone, host 102a may be requested to provide further authentication credentials to access one or more files in the first logical zone.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

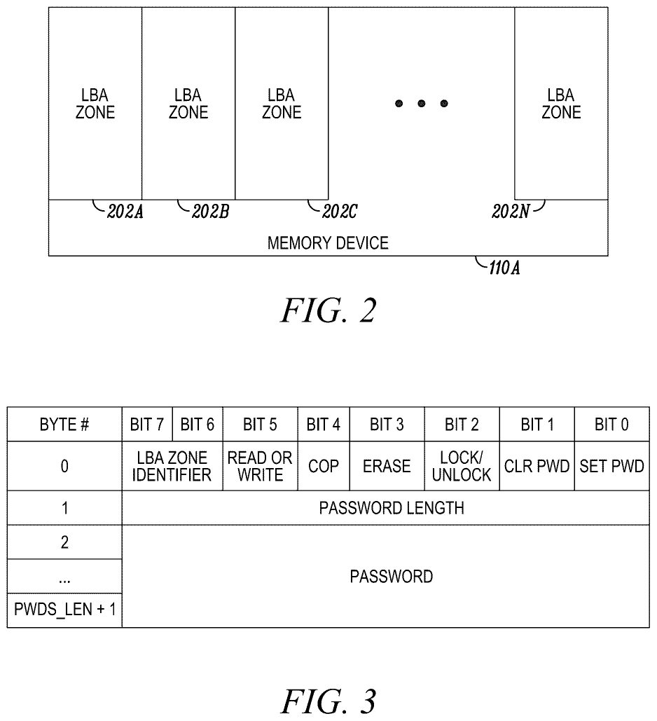

FIG. 2 is an example block diagram showing logical zones associated with a memory device in accordance with some implementations. Memory device 110 may be a 256-gigabyte device that may be associated with any number of logical/LBA zones (i.e., LBA zone 202a-202n, referred to generally as LBA zone 202) Each LBA zone 202 may include a range of LBAs and data associated with LBAs in a LBA zone may be protected according to a first data restriction policy associated with the LBA zone 202.

An authorized user (for example, host 102) of storage device 104 may view the complete drive space of 256-gigabyte. However, if, for example, the first data restriction policy for LBA zone 202a provides for read control protection, controller 108 may allow read access to data associated with LBAs in LBA zone 202a after host 102 provides authentication credentials associated with read access for LBA zone 202a. If, for example, the first data restriction policy for LBA zone 202a provides for no read control protection, controller 108 may allow host 102 to read data in LBA zone 202a when host 102 sends a read request for data associated with LBAs in LBA zone 202a. If, for example, the first data restriction policy for LBA zone 202b provides for write control protection, controller 108 may allow write access to LBA zone 202b after host 102 provides authentication credentials associated with write access for LBA zone 202b. If, for example, the first data restriction policy for LBA zone 202b provides for no write control protection, controller 108 may write host data associated with LBAs in LBA zone 202b when host 102 sends a write request associated LBA zone 202a. As indicated above FIG. 2 is provided as an example. Other examples may differ from what is described in FIG. 2.

FIG. 3 is an example block diagram of a command used to set the data restriction policy for a logical zone in accordance with some implementations. Command 302 may be, for example, a CMD42 command. Byte 0 of command 302may include a bit (Bit 0) that may be associated with setting a password, a bit (Bit 1) that may be associated with clearing the password, a bit (Bit 2) that may be associated with locking/unlocking a memory card, a bit (Bit 3) that may be associated with a force erase operation, a bit (Bit 4) that may be associated with card ownership protection (COP) feature operations, a bit (Bit 5) that may be associated with read protection control or write protection control according to the data protection policy of a logical zone, and bits (Bit 6 and Bit 7) that may be associated with a LBA zone identifier. Byte 1 of command 302 may define the password length in bytes. Bytes 2 to PWDS_LEN+1 may include password data. As indicated above FIG. 3 is provided as an example. Other examples may differ from what is described in FIG. 3.

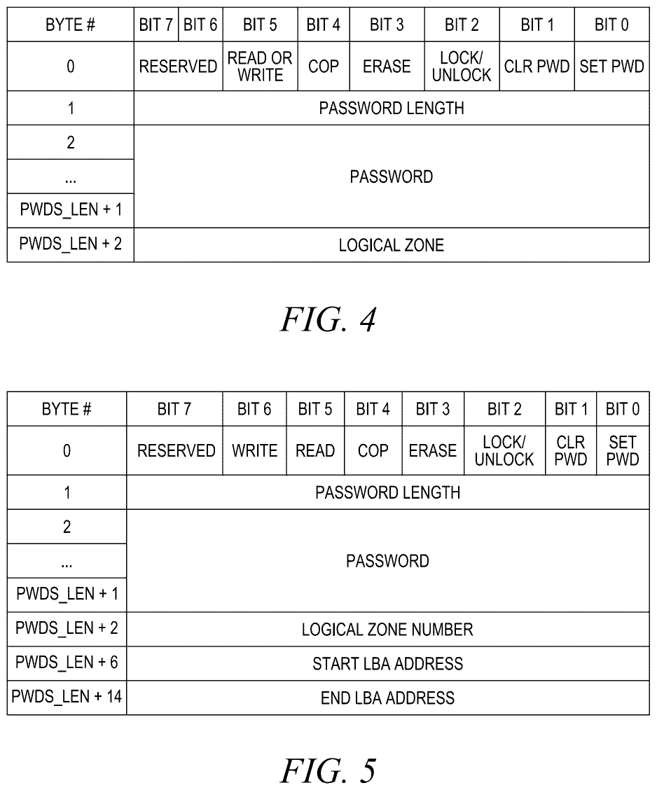

FIG. 4 is another example block diagram of a command used to set the data restriction policy for a logical zone in accordance with some implementations. Command 402 may be, for example, a CMD42 command. Byte 0 of command 402 may include a bit (Bit 0) that may be associated with setting a password, a bit (Bit 1) that may be associated with clearing the password, a bit (Bit 2) that may be associated with locking/unlocking a memory card, a bit (Bit 3) that may be associated with a force erase operation, a bit (Bit 4) that may be associated with COP feature operations, a bit (Bit 5) that may be associated with read protection control or write protection control according to the data protection policy of a logical zone, and bits (Bit 6 and Bit7) that may be reserved. Byte 1 of command 402 may define the password length in bytes. Bytes 2 to PWDS_LEN+1 may include password data. Byte PWDS_LEN+2 may include data to identify the logical zones associated with the data protection policy. As indicated above FIG. 4 is provided as an example. Other examples may differ from what is described in FIG. 4.

FIG. 5 is an example block diagram of a command used to set the data restriction policy for a file in a logical zone in accordance with some implementations. Command 502 may be, for example, a CMD42 command. Byte 0 of command 502 may include a bit (Bit 0) that may be associated with setting a password, a bit (Bit 1) that may be associated with clearing the password, a bit (Bit 2) that may be associated with locking/unlocking a memory card, a bit (Bit 3) that may be associated with a force erase operation, a bit (Bit 4) that may be associated with card ownership protection COP feature operations, a bit (Bit 5) that may be associated with read protection control according to the data protection policy of a logical zone, a (Bit 6) that may be associated with write protection control according to the data protection policy of the logical zone, and a bit (Bit 7) that may be reserved. Byte 1 of command 302 may define the password length in bytes. Bytes 2 to PWDS_LEN+1 may include password data. Byte PWDS_LEN+2 may include the number of logical zones associated with storage device 104. Bytes PWDS_LEN+6 may indicated a start LBA address associated with data in a logical zone such that in addition to accessing the logical zone according to the first data restriction policy of the logical zone, the data in the logical zone starting at the address provided in PWDS_LEN+6 may be further restricted with the password provided in command 502. Bytes PWDS_LEN+14 may indicate an end LBA address associated with data that is to be further protected in the logical zone. As indicated above FIG. 5 is provided as an example. Other examples may differ from what is described in FIG. 5.

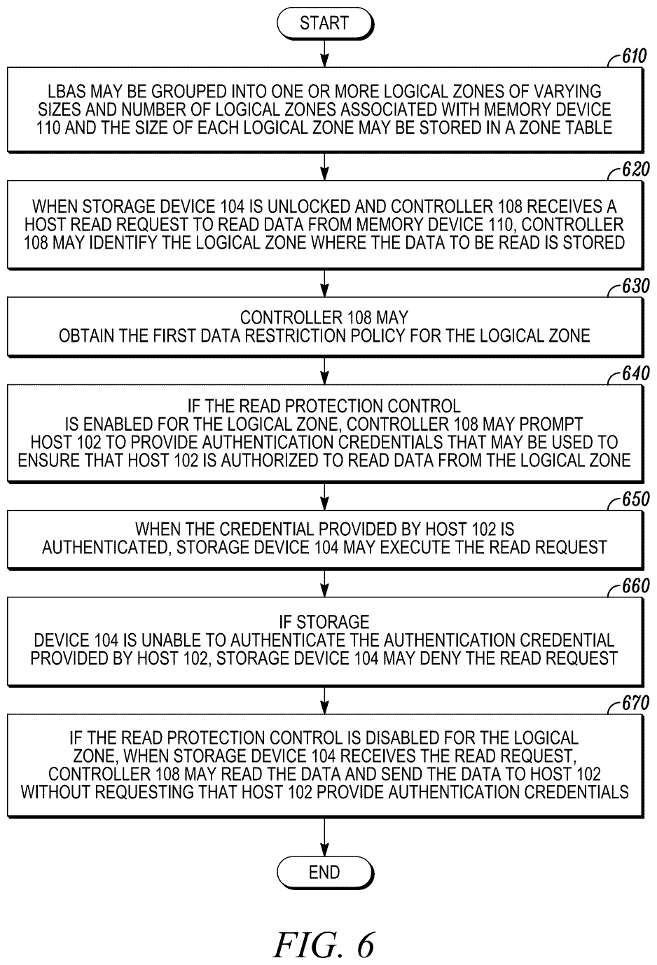

FIG. 6 is an example flow diagram for securing data on an unlocked storage device that is not partitioned in accordance with some implementations. At 610, LBAs may be grouped into one or more logical zones of varying sizes and number of logical zones associated with memory device 110 and the size of each logical zone may be stored in a zone table. At 620, when storage device 104 is unlocked and controller 108 receives a host read request to read data from memory device 110, controller 108 may identify the logical zone where the data to be read is stored. At 630, controller 108 may obtain the first data restriction policy for the logical zone. At 640, if the read protection control is enabled for the logical zone, controller 108 may prompt host 102 to provide authentication credentials that may be used to ensure that host 102 is authorized to read data from the logical zone. At 650, when the credential provided by host 102 is authenticated, storage device 104 may execute the read request. At 660, if storage device 104 is unable to authenticate the authentication credential provided by host 102, storage device 104 may deny the read request. At 670, if the read protection control is disabled for the logical zone, when storage device 104 receives the read request, controller 108 may read the data and send the data to host 102 without requesting that host 102 provide authentication credentials. As indicated above FIG. 6 is provided as an example. Other examples may differ from what is described in FIG. 6.

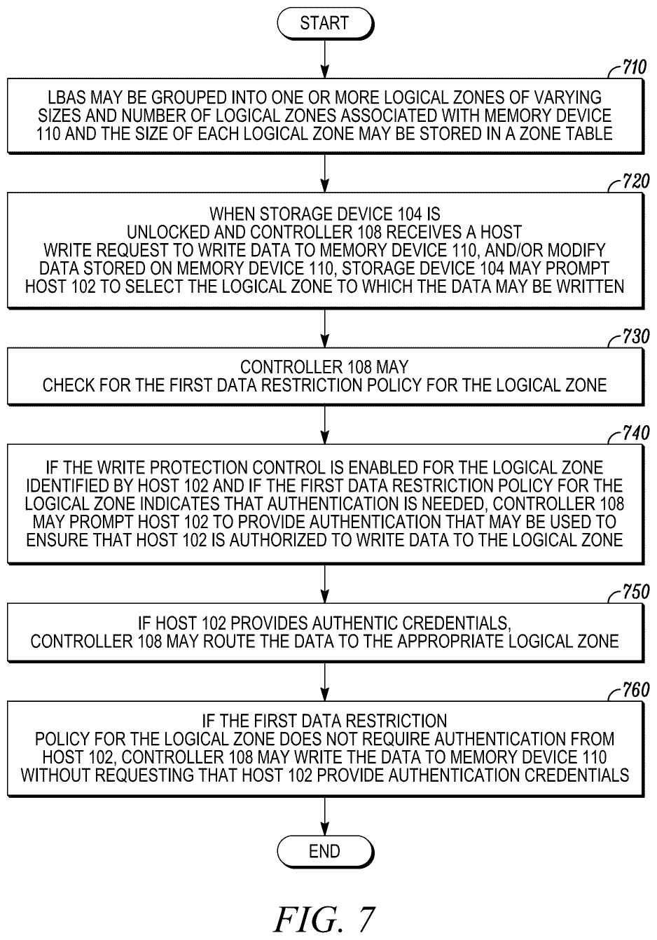

FIG. 7 is another example flow diagram for securing data on an unlocked storage device that is not partitioned in accordance with some implementations. At 710, LBAs may be grouped into one or more logical zones of varying sizes and number of logical zones associated with memory device 110 and the size of each logical zone may be stored in a zone table. At 720, when storage device 104 is unlocked and controller 108 receives a host write request to write data to memory device 110, and/or modify data stored on memory device 110, storage device 104 may prompt host 102 to select the logical zone to which the data may be written. At 730, controller 108 may check for the first data restriction policy for the logical zone. At 740, if the write protection control is enabled for the logical zone identified by host 102 and if the first data restriction policy for the logical zone indicates that authentication is needed, controller 108 may prompt host 102 to provide authentication that may be used to ensure that host 102 is authorized to write data to the logical zone. At 750, if host 102 provides authentic credentials, controller 108 may route the data to the appropriate logical zone. At 760, if the first data restriction policy for the logical zone does not require authentication from host 102, controller 108 may write the data to memory device 110 without requesting that host 102 provide authentication credentials. As indicated above FIG. 7 is provided as an example. Other examples may differ from what is described in FIG. 7.

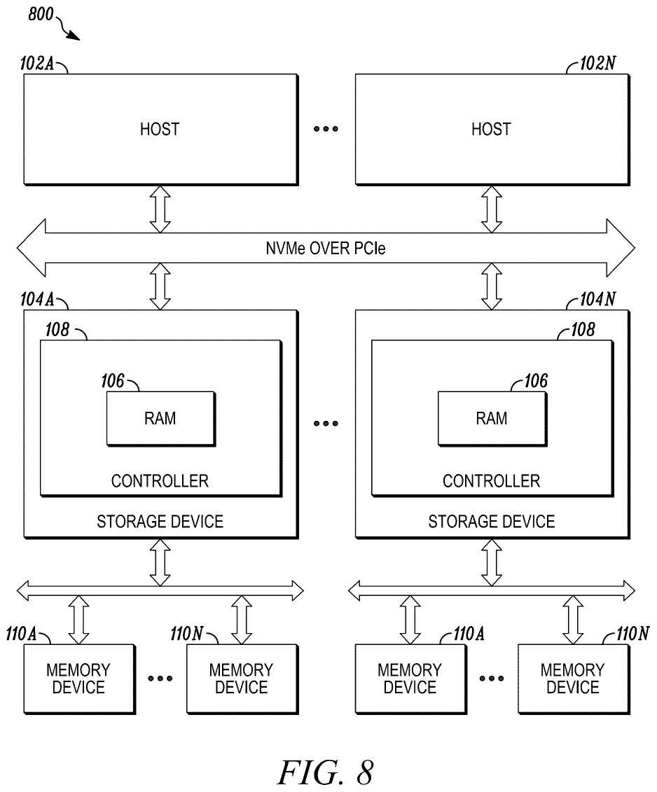

FIG. 8 is a diagram of an example environment in which systems and/or methods described herein are implemented. As shown in FIG. 8, Environment 800 may include hosts 102-102n (referred to herein as host(s) 102), and one or more storage devices 104a-104n (referred to herein as storage device(s) 104). Controller 108 may secure data on an unlocked storage device 104 that is not partitioned into dedicated drives. Hosts 102 and storage devices 104 may communicate via Non-Volatile Memory Express (NVMe) over peripheral component interconnect express (PCI Express or PCIe), SD, or the like.

Devices of Environment 800 may interconnect via wired connections, wireless connections, or a combination of wired and wireless connections. For example, the network in FIG. 8 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of Environment 800 may perform one or more functions described as being performed by another set of devices of Environment 800.

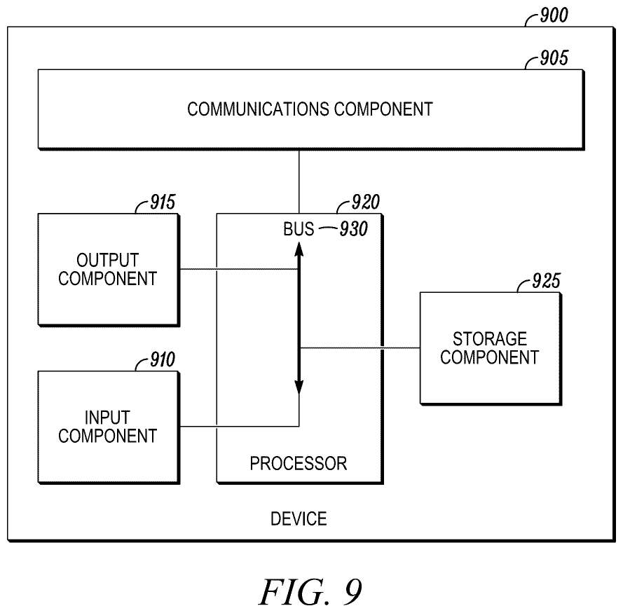

FIG. 9 is a diagram of example components of one or more devices of FIG. 1. In some implementations, host 102 may include one or more devices 900 and/or one or more components of device 900. Device 900 may include, for example, a communications component 905, an input component 910, an output component 915, a processor 920, a storage component 925, and a bus 930. Bus 930 may include components that enable communication among multiple components of device 900, wherein components of device 900 may be coupled to be in communication with other components of device 900 via bus 930.

Input component 910 may include components that permit device 900 to receive information via user input (e.g., keypad, a keyboard, a mouse, a pointing device, and a network/data connection port, or the like), and/or components that permit device 900 to determine the location or other sensor information (e.g., an accelerometer, a gyroscope, an actuator, another type of positional or environmental sensor). Output component 915 may include components that provide output information from device 900 (e.g., a speaker, display screen, and network/data connection port, or the like). Input component 910 and output component 915 may also be coupled to be in communication with processor 920.

Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 may include one or more processors capable of being programmed to perform a function. Processor 920 may be implemented in hardware, firmware, and/or a combination of hardware and software.

Storage component 925 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 920. A memory device may include memory space within a single physical storage device or memory space spread across multiple physical storage devices. Storage component 925 may also store information and/or software related to the operation and use of device 900. For example, storage component 925 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 905 may include a transceiver-like component that enables device 900 to communicate with other devices, such as via a wired connection, a wireless connection, or a combination of wired and wireless connections. The communications component 905 may permit device 900 to receive information from another device and/or provide information to another device. For example, communications component 905 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 905 may also include one or more broadband and/or narrowband transceivers and/or other similar types of wireless transceiver configurable to communicate via a wireless network for infrastructure communications. Communications component 905 may also include one or more local area network or personal area network transceivers, such as a Wi-Fi transceiver or a Bluetooth transceiver.

Device 900 may perform one or more processes described herein. For example, device 900 may perform these processes based on processor 920 executing software instructions stored by a non-transitory computer-readable medium, such as storage component 925. As used herein, the term “computer-readable medium” refers to a non-transitory memory device. Software instructions may be read into storage component 925 from another computer-readable medium or from another device via communications component 905. When executed, software instructions stored in storage component 925 may cause processor 920 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, or “contains ...a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to secure data stored on a memory device when the storage device is unlocked, the storage device comprises:
a memory device to store data; and
a controller to identify at least one logical zone associated with the memory device, establish a first data restriction policy associated with a logical zone to enforce access rules when the storage device is unlocked, set at least one bit in a command structure to establish a data protection policy for the logical zone, and execute the first data restriction policy when the storage device receives a request to access data in the logical zone.

2. The storage device of claim 1, wherein the controller sets a first bit in the command structure to one of enable and disable read protection control.

3. The storage device of claim 1, wherein the controller sets a first bit in the command structure to one of enable and disable write protection control.

4. The storage device of claim 1, wherein the controller sets a first bit in the command structure to one of enable and disable read protection control and sets a second bit in the command structure to one of enable and disable write protection control.

5. The storage device of claim 1, wherein the controller sets at least one third bit in the command structure to identify a number associated with the logical zone.

6. The storage device of claim 1, wherein the controller uses a byte in the command structure to identify a number associated with the logical zone.

7. The storage device of claim 1, wherein when the storage device receives a read request for data in the logical zone, the controller identifies the logical zone, obtains the first data restriction policy for the logical zone, determines that read protection control is enabled for the logical zone, prompts a requestor of the data for authentication credentials to access the data in the logical zone, and reads the data if the authentication credentials are valid.

8. The storage device of claim 1, wherein when the storage device receives a write request to write data to the logical zone, the controller obtains the first data restriction policy for the logical zone, determines that write protection control is enabled for the logical zone, prompts a requestor of the data for authentication credentials to write the data the logical zone, writes the data to the memory device if the authentication credentials are valid and associates a logical block address for the data with the logical zone.

9. The storage device of claim 1, wherein when data to be written to the memory device is associated with multiple logical zones, the controller uses a starting logical block address to identify the first data restriction policy.

10. The storage device of claim 1, wherein during garbage collection the controller updates a logical zone password associated with relocated data.

11. The storage device of claim 1, wherein the controller sets a second data restriction policy for data in the logical zone, wherein the controller provides a start logical block address and an end logical block address for the data in the command structure.

12. The storage device of claim 1, wherein a number of logical zones associated with the memory device and a size of the logical zone are stored in a zone table.

13. A method in a storage device for securing data stored on a memory device when the storage device is unlocked, the storage device comprises a controller to execute the method comprising:
identifying at least one logical zone associated with the memory device;
establishing a first data restriction policy associated with a logical zone to enforce access rules when the storage device is unlocked;
setting at least one bit in a command structure to establish a data protection policy for the logical zone;
receiving an access request to access data associated with the logical zone; and
executing the first data restriction policy.

14. The method of claim 13, further comprising one of setting a first bit in the command structure to one of enable and disable read protection control and setting the first bit in the command structure to one of enable and disable write protection control.

15. The method of claim 13, further comprising setting a first bit in the command structure to one of enable and disable read protection control and setting a second bit in the command structure to one of enable and disable write protection control.

16. The method of claim 13, further comprising one of setting at least one third bit in the command structure to identify a number associated with the logical zone and using a byte in the command structure to identify a number associated with the logical zone.

17. The method of claim 13, further comprising:
receiving a read request for data in the logical zone;
identifying the logical zone;
obtaining the first data restriction policy for the logical zone;
determining that read protection control is enabled for the logical zone;
prompting a requestor of the data for authentication credentials to access the data in the logical zone; and
reading the data if the authentication credentials are valid.

18. The method of claim 13, further comprising:
receiving a write request to write data to the logical zone;
obtaining the first data restriction policy for the logical zone;
determining that write protection control is enabled for the logical zone;
prompting a requestor of the data for authentication credentials to write the data the logical zone; and
writing the data to the memory device if the authentication credentials are valid and associating a logical block address for the data with the logical zone.

19. The method of claim 13, further comprising using a starting logical block address to identify the first data restriction policy when data to be written to the memory device is associated with multiple logical zones.

20. A method in a storage device for securing data stored on a memory device when the storage device is unlocked, the storage device comprises a controller to execute the method comprising:
identifying at least one logical zone associated with the memory device;
establishing a first data restriction policy associated with a logical zone to enforce access rules when the storage device is unlocked and establishing a second data restriction policy associated with data in the logical zone;
setting at least one bit in a command structure to establish a data protection policy for the logical zone;
receiving a first access request to access the logical zone;
executing the first data restriction policy;
receiving a second access request to access the data in the logical zone; and
executing the second data restriction policy.
